(19) United States
(12) Patent Application Publication
(10) Pub. No.: US 2009/0278900 A1
(43) Pub. Date: Nov. 12, 2009

(54) INK JET PRINTING APPARATUS AND INK TANK FOR THE SAME

(75) Inventors: Soji Kondo, Kawasaki-shi (JP); Kenta Udagawa, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/065,277

(22) PCT Filed: Dec. 5, 2006
(86) PCT No.: PCT/JP2006/324617

§ 371 Date: Feb. 28, 2008

(30) Foreign Application Priority Data
Dec. 5, 2005 (JP) 2005-350806

(51) Int. Cl. B41J 2/175

(52) U.S. Cl. 347/85

(57) ABSTRACT

In an intermittent ink supplying system, an ink supply base 3 forming a supply-path forming member is made capable of moving along with the movement for joining a sub-joint (4) with a sub-tank. In addition, an ink-supply-port forming member 8 of a main tank (2) connected to a main joint (8) is also made capable of moving in order to allow the ink supply base (3) to move. This prevents unpreferable stresses from acting on various parts of the supply-path forming member and the main tank, and the preferable joining condition can be obtained even when an inflexible ink-supply-path forming member with a relatively high stiffness is adopted. In addition, this increases a degree of freedom of material selection for the supply-path forming member, and improves the liquid resistance property, durability and gas barrier property.

### TECHNICAL FIELD

The present invention relates to an ink jet printing apparatus and an ink tank for the apparatus. The present invention is suitable for a configuration to which an intermittent ink supplying system is applied. In particular, the intermittent ink supplying system according to the present invention includes a reservoir for reserving a relatively small amount of ink in a printing head, in which an ink supply path for communicating an ink tank with the reservoir is joined to/disjoined from the reservoir at an appropriate timing, and ink is supplied from the ink tank to the reservoir when the ink supply path is joined to the reservoir.

### BACKGROUND ART

Ink jet printing apparatuses includes a so-called serial-type ink jet printing apparatus which uses a system for forming an image by causing a printing head to reciprocally scan back and forth in predetermined directions on a printing medium, and by conveying the printing medium in a direction orthogonal to the above predetermined directions. As an ink supplying system employed in such an ink jet printing apparatus, there is an on-carriage system. In the on-carriage system, ink is supplied from an ink tank attached to a printing head which is mounted on a carriage or the like, and which reciprocally moves (main scan). Note, that the ink tank may be attached to the printing head either integrally and undetachably or detachably.

In recent years, there have been strong demands for a downsized ink jet printing apparatus (hereinafter, also referred to as a printer), and for a performance capable of printing a high quality image at a high speed. To achieve these objects, a high-speed and stable movement of the carriage is required. Smaller and lighter-weight carriage, ink tank or the like mounted thereon are more favorable for this purpose. However, an attempt to reduce the size and weight of the ink tank necessarily results in a reduction in the volume of ink contained in the ink tank. This forces a user to frequently exchange the ink tanks.

Thus, recently, an advantage of employing an off-carriage system has been recognized anew. In the off-carriage system, the ink tank and the printing head are separate bodies, and the ink tank is fixedly mounted to a portion in a printer other than a printing head mounted on a carriage. Then, the ink tank and the printing head are connected to each other to supply ink. Above all, a printer having the following configuration is effective for the purpose of reducing the sizes and weights of a carriage and a component mounted thereon. This printer includes a reservoir which is provided in a printing head or a carriage, and in which a relatively small amount of ink is reserved. In the printer, an ink supply path for communicating the ink tank with the reservoir is joined to/disjoined from the reservoir at an appropriate timing, and ink is supplied from the ink tank to the reservoir when the ink supply path is joined to the reservoir. Such ink supplying system is referred to as an intermittent ink supplying system for the sake of simplicity. A particularly advantageous printer for the purpose of reducing the size of printer and stabilizing the movement of carriage has a configuration in which fluid communications are established between the ink reservoir of the printing head and the fixed ink tank when a carriage is positioned at a predetermined place. This printer is particularly effective because the configuration does not need a tube or the like that follows the movement of the carriage.

Such intermittent ink supplying system is disclosed in Japanese Patent Applications Laid-open No. 2003-127411 and No. 10-235892 (1998). According to the description in these documents, ink in an ink reservoir (hereinafter referred to as a sub-tank) located in a carriage is used during a printing operation. Also according to the description, when the ink in the sub-tank becomes little in amount, the carriage is moved to a predetermined position, and the sub-tank is joined with an ink-supply-path forming member, which communicates with an ink tank (hereinafter referred to as a main tank) fixed to the printer. Thus, the sub-tank receives ink supply.

In a case where such an ink supplying system is adopted, a flexible member such as a flexible tube has been used for the ink-supply-path forming member. A possible reason for this is that such a tube is easy to perform a piping and that such a tube can increase a degree of freedom for the layout of the ink tank and the like in the apparatus. However, the ink-supply-path forming member needs also to satisfy the liquid resistance property, durability, gas barrier property, and the like.

An ink supply path formed of a material having a low liquid resistance property is likely to be eroded by ink. This erosion may occur in a case where a printer is left without operating for a long time, or in a case where the printer is repeatedly used. Then, the substances constituting the supply-path forming member dissolved by the erosion are likely to enter the supply path and then to reach nozzles of a printing head and the like. This deteriorates the ink supply performance and the ink ejection performance, resulting in a decrease in the quality of printing.

Moreover, an ink supply path formed of a material having a low durability may suffer from a fatigue breakdown in the ink supply path, which is caused by the repeated use of a printer, and ink may leak out from the place of the fatigue breakdown.

In addition, in an ink supply path formed of a material having a low gas barrier property, bubbles tend to enter the ink supply path more frequently, and to be mixed with the ink. Avoiding the deterioration of the ink supply performance and the ink ejection performance requires an installation of a mechanism of appropriately purging the bubbles out. This installation, however, leads to an increase of a printer price. Furthermore, the moisture in the ink tends to evaporate more easily through the wall of the member. This results in an increased concentration of ink and an increased adhesion of ink components, and thus impedes the ink supply performance and the ink ejection performance. As a result, the quality of printing is likely to decrease.

Nevertheless, it is extremely difficult to improve the liquid resistance property, durability and gas barrier property, while having the preferable flexibility as described above. Specifically, a flexible tube with a larger wall thickness can improve the liquid resistance property and gas barrier property, but the preferable flexibility is likely to be sacrificed. In addition, the larger wall thickness of the flexible tube increases the cost of the ink-supply-path forming member, and eventually the cost of the printer. On the other hand, a flexible tube with a smaller wall thickness can easily ensure the desired flexibility, but the liquid resistance property and gas barrier property are likely to be decreased.

In contrast to the configuration with a flexible tube, Japanese Patent Applications Laid-open No. 2004-50470 and No. 2004-50624 disclose a configuration in which ink absorption elements are respectively provided to a side of the printing head or the carriage on which the printing head is mounted (ink receiving side), and a side of the ink supply path. In the description of these documents, ink is supplied by setting a capillary force of the absorption element of the ink receiving side to be larger than that of the ink supplying side, while the absorption element of the ink supplying side is in contact with the ink in a main tank. These documents do not clearly specify the material of the housing portion for the absorption element of the ink supplying side. However, Japanese Patent Application Laid-open No. 2004-50470 describes a joint portion allows the absorption elements to come into contact with each other in a way that a part of the joint portion moves in response to a contact with a fixed structure of the ink receiving side. Moreover, Japanese Patent Application Laid-open No. 2004-50624 describes a joint portion that opens a shutter provided to the ink receiving side and preventing the ink from drying out. The shutter is opened before the absorption elements come into contact with each other. In consideration of the descriptions about these joint portions that move and perform the opening operation, it is suggested that each of the absorption elements of the ink supplying sides is housed in an inflexible, that is, hard pipe-like member including the joint portion. It is preferable to form the ink-supply-path forming member of a hard material as in the foregoing description, since this widens a range of material selection in taking into account the liquid resistance property, durability and gas barrier property.

However, in a case where an inflexible ink-supply-path forming member having a relatively high stiffness as a whole is adopted, unpreferable stresses act on various portions of the ink-supply-path forming member and the main tank. As a result, the ink-supply-path forming member and the main tank may get out of their proper positions, and the damage may occur in a portion in which the stresses concentrate.

In addition, Japanese Patent Application Laid-open No. 2004-74781 discloses a configuration in which an ink supply path is formed as a part of an ink cartridge housing an ink bag, and in which the ink supply path can be brought into contact with and be detached from a printing head by driving the entire ink cartridge up and down. With this configuration, no unpreferable stress may possibly occur since the ink cartridge is not rigidly fixed.

Nevertheless, this is a configuration in which the ink supply path is integrated with the ink cartridge, and thus the configuration makes the degree of layout freedom of each component in an apparatus lower. To be more precise, this configuration places mutual constraints on the position where the printing head and the ink supply path are in contact with each other in order to supply ink, the position on which the ink cartridge is mounted or provided, and the configuration, the shape and the dimensions of the ink cartridge including the ink supply path. In addition to the printer apparatus disclosed in Japanese Patent Application Laid-open No. 2004-74781, this problem also arises in a case of the printing apparatus disclosed in each of Japanese Patent Applications Laid-open No. 2004-50470 and No. 2004-50624.

### DISCLOSURE OF THE INVENTION

The present invention has been made in consideration of the foregoing circumstances. An object of the present invention is to provide a configuration which is capable of causing a sub-tank to preferably be joined with an ink-supply-path forming member, or with a main tank, and which is excellent in the liquid resistance property, durability and gas barrier property.

Another object of the present invention is to prevent unpreferable stresses from occurring when an ink supply path for supplying ink is in contact with a printing head, while improving the degree of layout freedom of each component in an apparatus.

In order to achieve the objects, in an aspect of the present invention, there is provided an ink jet printing apparatus which uses a printing head capable of ejecting ink, an ink reservoir holding ink to be supplied to the printing head, and an ink tank with a larger volume of ink contained therein than in the ink reservoir, and in which ink is supplied from the ink tank to the ink reservoir by intermittently making fluid communication between the ink tank and the ink reservoir, the ink jet printing apparatus comprising,

a supply-path forming member provided for the ink supply, the supply-path forming member integrally including a joint portion capable of being joined with the ink reservoir, and a connection portion connected to the ink tank, and in which a channel for supplying ink is formed between the joint portion and the connection portion, wherein:

the supply-path forming member is configured of a member of an inflexible material; and

movement of the entire supply-path forming member causes the joint portion to be joined with and to be disjoined from the ink reservoir.

In another aspect of the present invention, there is provided an ink tank capable of being mounted on a fixed position in the above ink jet printing apparatus, wherein

in a state where the ink tank is mounted on the ink jet printing apparatus, an ink-supply-port forming member, which is connected to the connection portion, provided for introducing the ink, of the ink jet printing apparatus, is supported movably together with the connection portion.

According to the present invention, the supply-path forming member is configured of a single piece of inflexible member including the joint portion to be joined with the ink reservoir (the sub-tank) and the connection portion to be connected to the ink tank (the main tank). Thus, the supply-path forming member can move as a whole in order to be joined with the ink reservoir. Moreover, an ink-supply-port forming member is movably provided to the ink tank, and is to be connected to the connection portion of the ink jet printing apparatus. Thereby, even when an inflexible ink-supply-path forming member with a relatively high stiffness, as a whole, is employed, a preferable joining condition can be obtained with a simple configuration, while the configuration prevents unpreferable stresses from acting on various portions of the ink-supply-path forming member and the main tank, and prevents a driving force from increasing. In addition, this configuration can increase a degree of freedom of material selection for the ink-supply-path forming member, and can improve the liquid resistance property, durability and gas barrier property.

Further features of the present invention will become apparent from the following description of exemplary embodiments (with reference to the attached drawings).

### BRIEF DESCRIPTION OF THE DRAWINGS

FIG. 1 is a conceptual diagram for explaining a schematic configuration of an ink jet printer to which an intermittent ink supplying system is applied;

FIG. 2 is a perspective view of an ink supplying system of a printer according to an embodiment of the present invention;

FIGS. 3A and 3B are perspective views of an ink supply base of the embodiment shown in FIG. 2 when viewed from different directions, respectively;

FIG. 4A is a perspective view showing an external appearance of the main tank of the embodiment shown in FIG. 2;

FIG. 4B is a cutaway perspective view for showing the inside of the main tank;

FIGS. 5A and 5B are explanatory diagrams of fixing and releasing movement of the ink-supply-port forming member disposed in the main tank shown in FIGS. 4A and 4B;

FIG. 6 is a perspective view showing, by cutting away a part of the ink supply base, a vicinity of an engaging potion of the ink supply base with the main tanks;

FIG. 7A is a perspective view showing a state in which sub-joints are joined with the respective sub-tanks by causing the ink supply base to move upward from the state shown in FIG. 2, while FIG. 7B is a perspective view showing the vicinity of the engaging portion of the ink supply base with the main tanks at this time;

FIG. 8A is a cross sectional view of the main tank in a state where the ink-supply-port forming member of the main tank is located on the lower side, while FIG. 8B is a cross sectional view of the main tank after the ink-supply-port forming member of the main tank moves upward;

FIG. 9 is a cutaway perspective view showing a vicinity of an engaging portion of an ink supply base with main tanks in an ink supplying system of a printer according to a second embodiment of the present invention;

FIG. 10A is a perspective view showing an external appearance of the main tank of the embodiment shown in FIG. 9, and FIG. 10B is a cutaway perspective view for showing the inside of the main tank;

FIG. 11 is a perspective view showing a state in which sub-joints are joined with the respective sub-tanks by causing the ink supply base to move upward from a state shown in FIG. 9;

FIG. 12A is a cutaway perspective view showing a vicinity of an engaging portion of an ink supply base with main tanks in an ink supplying system of a printer according to a third embodiment of the present invention, and

FIG. 12B is a perspective view showing a state after the ink supply base is moved upward.

### BEST MODE FOR CARRYING OUT THE INVENTION

Descriptions will be given below for the present invention by referring to the drawings.

### First Embodiment

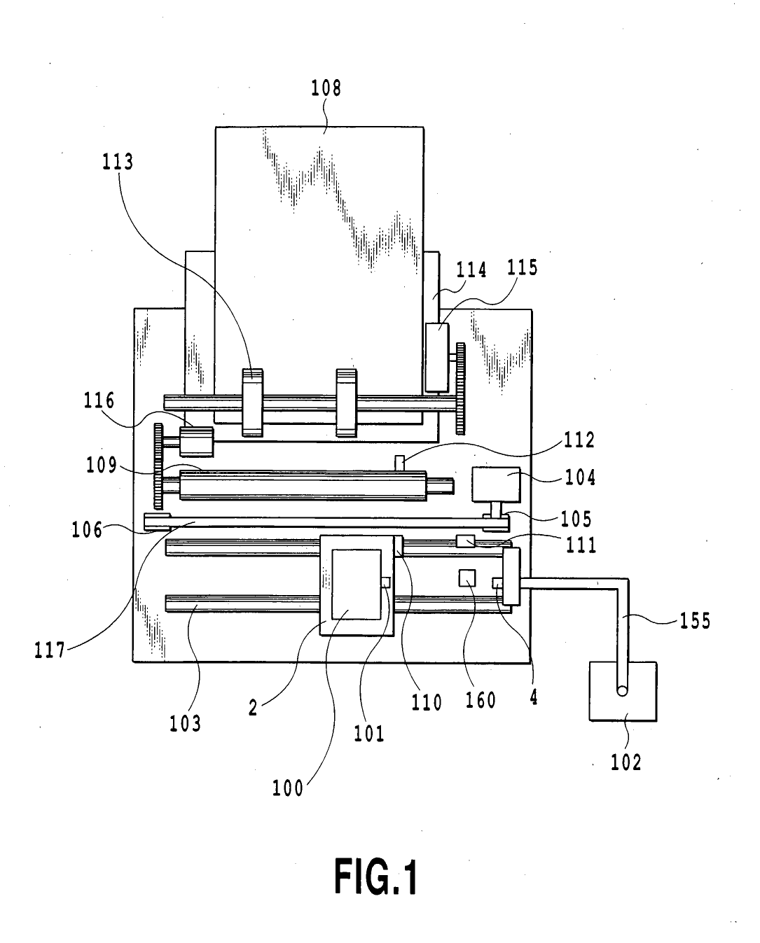

FIG. 1 is a conceptual diagram for explaining a schematic configuration of an ink jet printer to which an intermittent ink supplying system is applied. Note that, although FIG. 1 shows only one ink supplying path from a main tank to a printing head for the purpose of simplification, a plurality of ink supplying paths are provided depending on the number of ink colors used in the printer as a matter of course.

In FIG. 1, a printing head unit 100 is exchangeably mounted on a carriage 1. A printing head including an ink ejection portion and a sub-tank (both of them may be formed to be the printing head unit 100) are mounted on the carriage 1. The carriage 1 is supported and guided in a way that the carriage 1 is capable of reciprocating along a guide shaft 103. The guide shaft 103 is installed in a printer body and extends in a main scan direction. A main scan motor 104 drives the carriage 1 via a transmission mechanism, which includes a motor pulley 105, a driven pulley 106 and a timing belt 117. In addition, the main scan motor 104 controls the position and the movement of the carriage 1 via the transmission mechanism. Moreover, the carriage 1 is provided with a home-position sensor 110 of a form of, for example, a transmission-type photo-interrupter. On the other hand, a shielding plate 111 is provided to a fixed portion of the printer, corresponding to the home position of the carriage. The shielding plate 111 is capable of shielding an optical axis of the transmission-type photo-interrupter. With this configuration, the home position is detected when the carriage 1 moves and the home-position sensor 110 passes above the shielding plate 111. Thus, it is possible to control the position and the movement of the carriage on the basis of the detected position.

A pick-up roller 113 is driven to rotate by a feed motor 115 via a gear, and thereby printing media 108 such as a printing paper sheet or a thin plastic sheet are fed from an automatic sheet feeder (ASF) 114, separately, one by one. Thereafter, the printing medium 108 is conveyed (sub-scan) by the rotation of a conveyance roller 109, and thus passes through a place (a printing portion) opposite to an ejection-opening forming face of the printing head unit 100. The rotation of a line feed (LF) motor 116 is transmitted to the conveyance roller 109 via a gear, and thus the conveyance roller 109 is driven.

At this time, based on an output from a paper-end sensor 112, a judgment is made as to whether or not a sheet is fed, and a print-start-position finding during paper feeding (the determination of a print-start position on a printing medium in a sub-scan direction) is carried out. The paper-end sensor 112 is provided to a printing medium conveyance path on an upstream side of the printing portion, and is used for detecting the presence or absence of a printing medium. In addition, the paper-end sensor 112 detects the rear end of the printing medium 108, and thus is used for determining the print-end position on the printing medium in the sub-scan direction on the basis of the output of the detected result.

Note that the back surface of a printing medium 108 is supported by a platen (not illustrated) so that the printing medium 108 would form the flat printing surface at the portion where the printing is actually carried out. In this case, the printing head unit 100 mounted on the carriage 1 is held so that the ejection opening forming face, downwardly protruding from the carriage 1, would be in parallel with the printing medium 108. The printing head unit 100 is, for example, a type of ink jet printing head unit which ejects ink using thermal energy, and which is provided with an electrothermal transducer element for generating the thermal energy causing film boiling of ink. To be more precise, the thermal energy applied by the electrothermal transducer element causes the film boiling of the ink to take place, and thus bubbles are generated in the ink. By using a pressure of the bubbles, the printing head of the printing head unit 100 ejects the ink from the ejection opening, and thus makes prints. Needless to say, the printing head unit 100 may be another type of printing head unit such as the one ejecting ink with a piezoelectric element.

Reference numeral 160 denotes a recovery mechanism including a cap member used for performing a suction recovery operation of recovering the printing head unit 100 by sucking the ink from the printing head unit 100, and for protecting the ejection opening forming face of the printing head. By an unillustrated motor, the cap member can be set to be at each of positions where the cap member is in contact with and is away from the ejection-opening forming face. When the cap member is in contact with the printing head, an unillustrated suction pump or the like generates a negative pressure inside the cap member. Thereby, the cap member performs the suction recovery operation or the like for the printing head. Moreover, when the printer is not in use, the ejection opening forming face of the printing head can be protected by leaving the cap member in contact with the ejection opening forming face.

Reference numeral 101 shows a joint portion for introducing the ink into the sub-tank. Reference numeral 4 denotes a joint portion which is mated with the joint portion 101, and which is provided at one end of an ink-supply-path forming member 155. These joint portions are joined with each other when the carriage 1 is set to be at the home position that is outside a printable area in a main scan direction, or at a position in the vicinity of the home position. At this position, the ejection opening forming face of the printing head is capped, and the suction pump is operated. Thereby, the ink can be introduced into the sub-tank from a main tank 2 through the ink-supply-path forming member 155.

Note that the figure illustrates, only for explanatory purpose, that the joint portions are joined with each other in a carriage moving direction. The purpose here is to explain the concept of the intermittent ink supplying system. Accordingly, it is obvious that the direction and the mode, in which the joint portions are joined with each other, can be appropriately determined. For example, as in an embodiment described later, the joint portion 4 may be joined with a joint portion of a sub-tank, by causing an ink-supply-path forming member 155 and its joint portion 4 to move upward, when a carriage is located at the home position. Furthermore, both joint portions may move, as long as the joint portions are joined with each other by causing both of the carriage including the sub-tank and the ink-supply-path forming member 155 including the joint portion 4 to get close relative to each other.

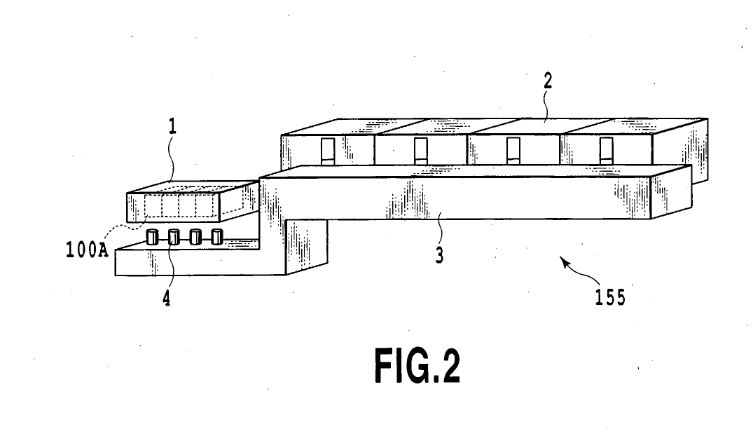

FIG. 2 is a perspective view of an ink supplying system of a printer according to an embodiment of the present invention. As described above, one or a plurality of sets each including a printing head for ejecting ink (not illustrated) and a sub-tank 100A are mounted on a carriage 1 (the carriage 1 illustrated in FIG. 2 is equipped with four sets). The sub-tank 100A is a small ink tank. Each of main tanks 2 is larger in capacity than the sub-tank 100A, and is detachably attached to a fixed position outside the carriage 1 in a printer body. An ink-supply-path forming member 155 is formed of an inflexible material, and includes an ink supply base 3 formed therein. Ink supply paths are used for connecting the sub-tanks to the respective main tanks. The ink supply base 3 has a function as the ink-supply-path forming member 155. The ink supply base 3 can have any appropriate structure and can be formed of any appropriate material, such as metal, hard resin, any combination thereof, as long as the material and the structure show preferable liquid resistance property, durability, and gas barrier property.

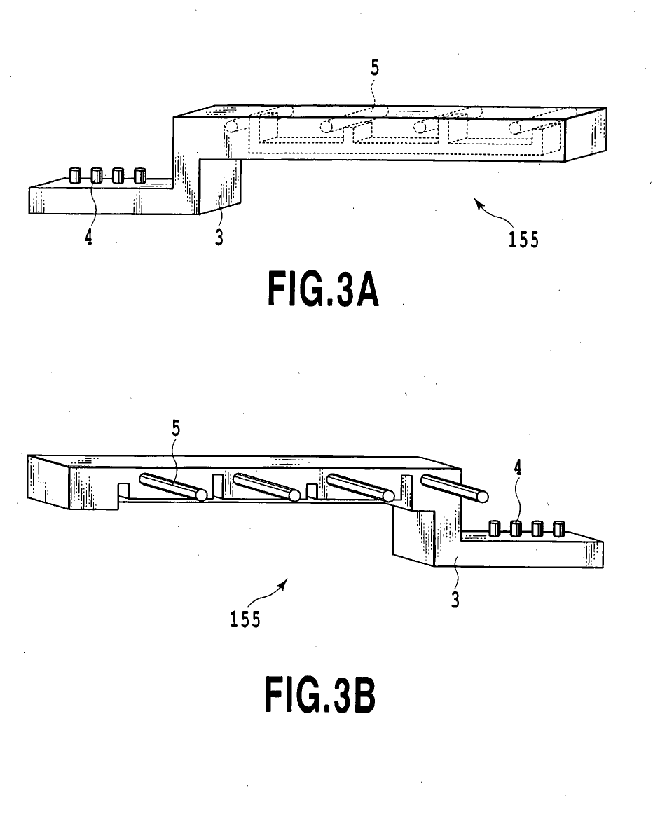

FIGS. 3A and 3B are perspective views of a configuration example of the ink supply base 3 when viewed from different directions, respectively. The ink supply base 3 includes the joint portions (hereinafter referred to as sub-joints) 4 in one end thereof. The sub-joints 4 are used for introducing ink into the respective sub-tanks 100A when the sub-joints 4 are respectively joined with joint portions 101 of the sub-tanks 100. In the other end thereof, the ink supply base 3 includes joint portions (hereinafter referred to as main joints) 5. The ink supply base 3 receives ink supply by connecting the main joints 5 respectively to the main tanks 2. Fluid communications can be established between each of the sub-joints 4 and corresponding one of the main joints 5. In addition, each of the sub-joints 4 can be joined to corresponding one of the sub-tanks 100A mounted on the carriage 1. The ink supply base 3 is a unit in which these joints are integrated, and is held being movable up and down by driving means (not illustrated) provided to the body. When the ink supply base 3 is located at an upper position, the sub-joints 4 are joined with the respective sub-ink tanks 100A.

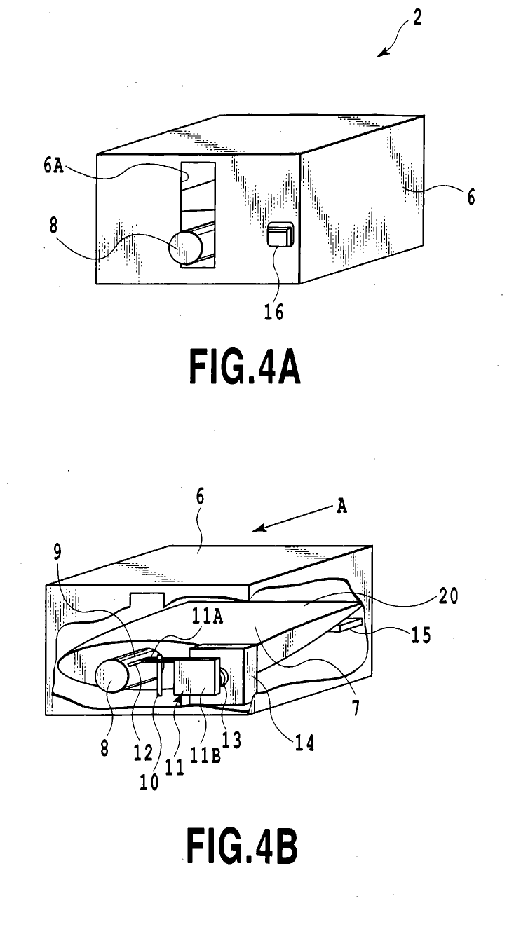

FIG. 4A is a perspective view of an external appearance of the main tank shown in FIG. 2. FIG. 4B is a perspective view of the main tank showing the inside thereof by cutting away a part of the main tank. An ink bag 7 serving as an ink container is housed inside an ink tank case 6 serving as an exterior package of the main tank 2. The ink bag 7 is provided with a member 8 forming an ink supply port to be connected to the main joint 5. A front end portion of the ink-supply-port forming member 8 is disposed at an opening 6A extending in a vertical direction of the ink tank case 6, and thus can be moved in a moving direction of the main joint 5, that is, can be moved up and down. In the ink-bag 7, an ink bag rear end portion 20 is located opposite to the end portion in which the ink-supply-port forming member 8 is disposed. The ink-bag rear end portion 20 is fixed by an ink-bag supporting member 15, and thus is kept at a higher position than the bottom face of the ink tank case 6.

On an outer circumferential face 9 of the ink-supply-port forming member 8, a groove 12 with an appropriate shape is cut along a longitudinal direction parallel with a main tank mounting direction A. A pivot member 11 is provided pivotably around a fixed shaft 10 perpendicular to the main tank mounting direction A. A first end 11A of the pivot member 11 is capable of engaging with the groove 12. A second end 11B of the pivot member 11 is biased in the ink tank mounting direction A with a spring 13 that is provided to a fixed supporting member 14.

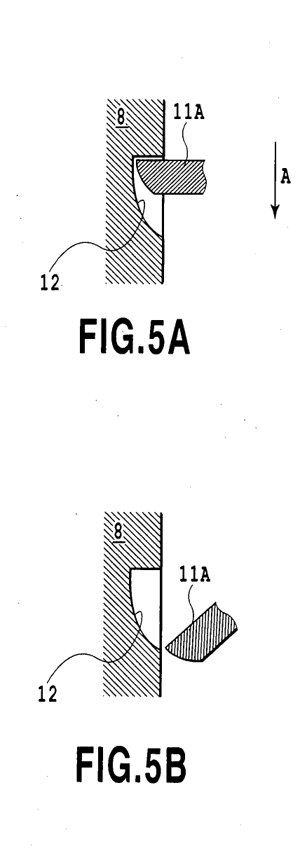

When the main tank 2 is not mounted, the second end 11B of the pivot member 11 is pressed in the main tank mounting direction A with the spring 13. Thus, the pivot member 11 pivots around the shaft 10, and the first end 11A of the pivot member 11 engages with the groove 12, for example, as shown in FIG. 5A. Thereby, the first end 11A of the pivot member 11 fixes the ink-supply-port forming member 8 by using the groove 12, and thus avoids the displacement of the ink-supply-port forming member 8.

The ink tank case 6 is provided with a window 16 for exposing the second end 11B of the pivot member 11. Thus, it is possible to cause the pivot member 11 to pivot against a biasing force of the spring 13 by pressing the second end 11B through the window 16 from the outside of the main tank 2.

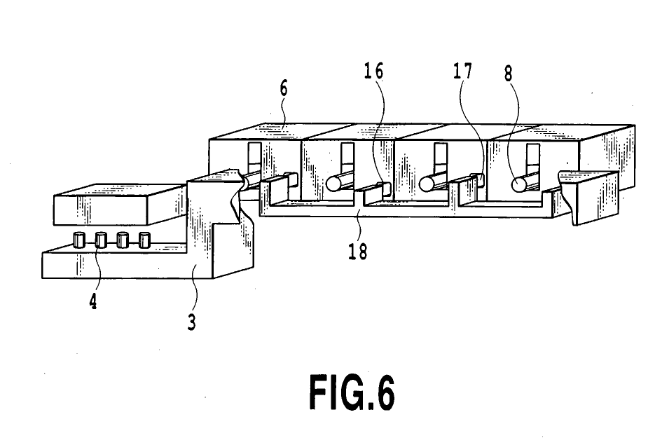

FIG. 6 is a cutaway perspective view showing, by cutting away a part of the ink supply base 3, the vicinity of an engaging potion of the ink supply base 3 with the main tanks 2. Each of protrusions 17 serving as an engaging member is provided at a place where the protrusion 17 can engage with the corresponding second end 11B of the pivot member 11. Each of the protrusions 17 is supported by a protrusion supporting member 18 fixed to the printer body. When each of the main tanks 2 is mounted on the printer body, corresponding one of the protrusions 17 engages with the second end 11B of the pivot member 11 through the window 16, and thus causes the pivot member 11 to pivot against the biasing force of the spring 13. At a time when the mounting of the main tank 2 is completed, the first end 11A of the pivot member 11 disengages from the groove 12 of the ink-supply-port forming member 8, for example, as shown in FIG. 5B. Thus, the fixation of the ink-supply-port forming member 8 is released. This makes it possible to cause the ink-supply-port forming member 8 to move along the opening, 6A with the up-and-down movements of the ink supply base 3, while the main joints 5 being surely connected to the ink-supply-port forming member 8.

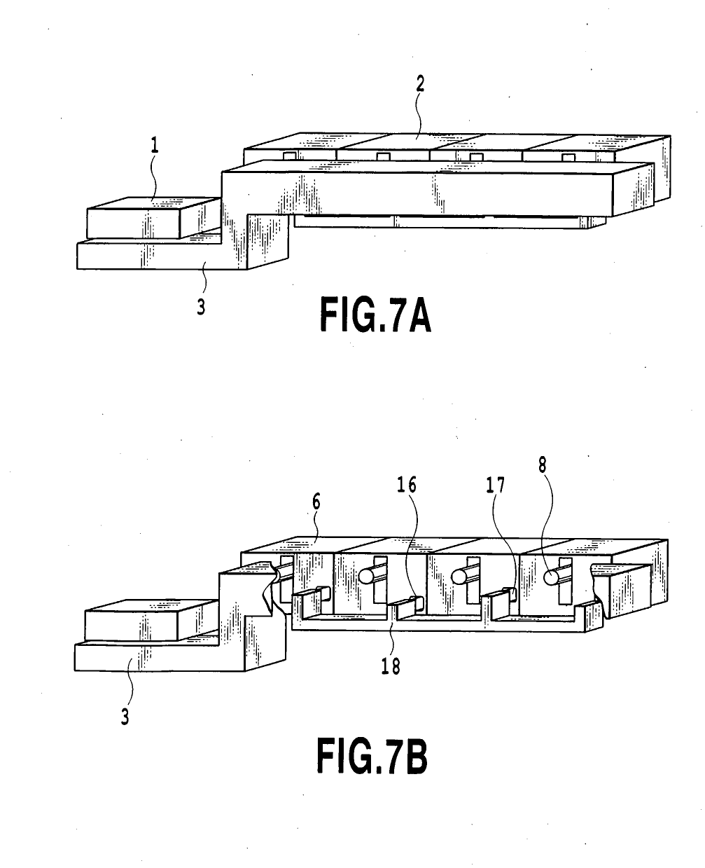

FIG. 7A is a perspective view showing a state in which the sub-joints 4 are joined with the respective sub-tanks 100A, by causing the ink supply base 3 to move upward from the state shown in FIG. 2. FIG. 7B is a perspective view showing the vicinity of a portion where the ink supply base 3 engages with the main tanks 2 in the state shown in FIG. 7A.

In order to obtain the engaging state shown in the drawings, the ink supply base 3 is moved upward by driving means (not illustrated) installed in the printer body. With this upward movement, the main joints 5 also move upward. Each of the main joints 5 is allowed to move upward, since the corresponding ink-supply-port forming member 8 of the main tank 2 connected to the main joint 5 can move in the opening 6A. Note that the ink tank case 6 itself does not move, since the ink-supply-port forming member 8 and the ink bag 7 are not rigidly fixed in the ink tank case 6.

As mentioned above, according to this embodiment, it is possible to increase the degree of freedom of material selection for the ink-supply-path forming member, and to improve the liquid resistance property, durability and gas barrier property.

In addition, the ink supply base 3 is a member provided as a separate body from the main tanks 2. This increases the degree of layout freedom of the main tanks 2, each serving for corresponding one of the sub-tanks 104, and thus improves the degree of layout freedom of each component in the apparatus.

Moreover, it is possible to allow the ink supply base 3 forming the ink-supply-path forming member to move along with a movement for joining the sub-joints 4 to the respective sub-tanks 100A. It is also possible to change the position of the ink-supply-port forming members 8 of the main tanks 2 connected to the main joints 5, for the purpose of allowing the ink supply base 3 to move. Specifically, the ink supply base 3 is not rigidly fixed to the ink tank case 6 itself, and thus can move independently from the ink tank case 6. This makes it possible to prevent unpreferable stresses from acting on various portions of the ink-supply-path forming member and the main tank, and to obtain a preferable engaging state, even when a flexible member for the ink-supply-path forming member is not used, that is, even when an inflexible ink-supply-path forming member with relatively high stiffness or rigidity as a whole is adopted. In addition, this makes a driving force so small as to change the positions of the ink supply base 3, and eventually, the ink bags 7, sufficient.

Furthermore, according to this embodiment, the ink bags 7 also move up and down along with the movement of the ink supply base 3. In a case of using ink in which color material components are easily settled down, for example, ink including pigment as coloring materials, this configuration is effective since a mixing effect can be obtained.

Additionally, by using the configuration of the embodiment described above together with the following configuration, it is possible to obtain an additional preferable advantageous effect.

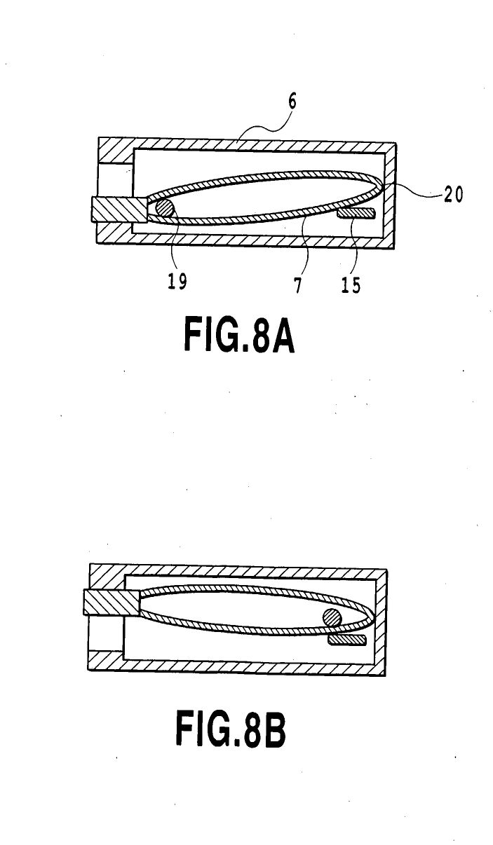

FIG. 8A is a cross sectional view of the main tank in a state where the ink-supply-port forming member 8 of the main tank 2 is located at the lower position. FIG. 8B is a cross sectional view of the main tank in a state where the ink-supply-port forming member 8 of the main tank 2 has moved to a upper position. A movable member 19 with a predetermined shape (for example, a sphere) is contained in the ink bag 7. The movable member 19 is capable of moving freely inside the ink bag 7. The ink-supply-port forming member 8 moves up and down (rises and falls) along with the join/disjoin between the sub-joints 4 and the sub-tanks 100A, while the ink bag rear end portion 20 is supported by the ink bag supporting member 15. Thus, the ink bag 7 swings around a portion thereof where the ink bag 7 is supported by the supporting member 15. In this way, relative vertical positions of the ink-supply-port forming member 8 and the position of the ink bag rear end portion 20 are reversed. In a case where the ink-supply-port forming member 8 moves upward, the movable member 19 moves toward the ink bag rear end portion 20. Meanwhile, in a case where the ink-supply-port forming member 8 moves downward, the movable member 19 moves away from the ink bag rear end portion 20. These movements can be used for improving the mixing effect on the ink contained in the ink bag 7. This configuration is even more effective in a case of using ink in which color material components are more easily settled down.

In a printer using a plurality of color inks, for example, four color inks of black, cyan, magenta and yellow, the order of arrangement of printing heads of the respective colors is specified for the purpose of obtaining the exact color reproduction of an image. With this specification, a main tank in which an ink of each color is contained should be mounted on a predetermined regular position. For this reason, it is preferable that the printer be provided with a mechanism causing a main tank to be mounted on an appropriate position corresponding to the color.

In the foregoing embodiment, the protrusion 17 is provided to the printer and the window 16 is provided to the main tank 2. The protrusion 17, through the window 16, causes the pivot member 11 to pivot, and thereby releasing the fixation of the ink-supply-port forming member 8. Now, a color of ink determines the relationship of one of the protrusions 17 of the printer to one of the windows 16, or one of the pivot members 11, of the main tank 2. This allows a main tank to be mounted, only in a case where the main tank containing a color ink is mounted on a proper position corresponding to the color of the ink. For example, in this embodiment, as shown in FIG. 6 and FIG. 7B, the relationship between each one of the protrusions 17 and the corresponding one of the windows 16, or pivot members 11, is determined by one of the colors. Thus, even when a user tries to mount a main tank containing a certain color ink on an improper position, this mechanism can prevent the user from making a mistake in mounting.

Note that, in this mechanism, in addition to color tones (colors and densities), various characteristics, in general, of the types of ink contained in the tanks may determine the relationship. In other words, this mechanism can be provided for the purpose of avoiding a mistake in mounting a main tank containing an ink having incompatible characteristics and a main tank not conforming to the configuration of a printer. In addition, it is possible to use the shapes of the protrusions 17, the windows 16 and the pivot members 11, instead of the positional relationships therebetween.

### Second Embodiment

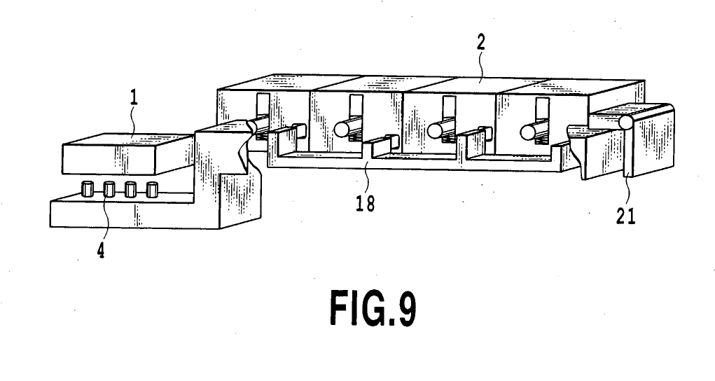

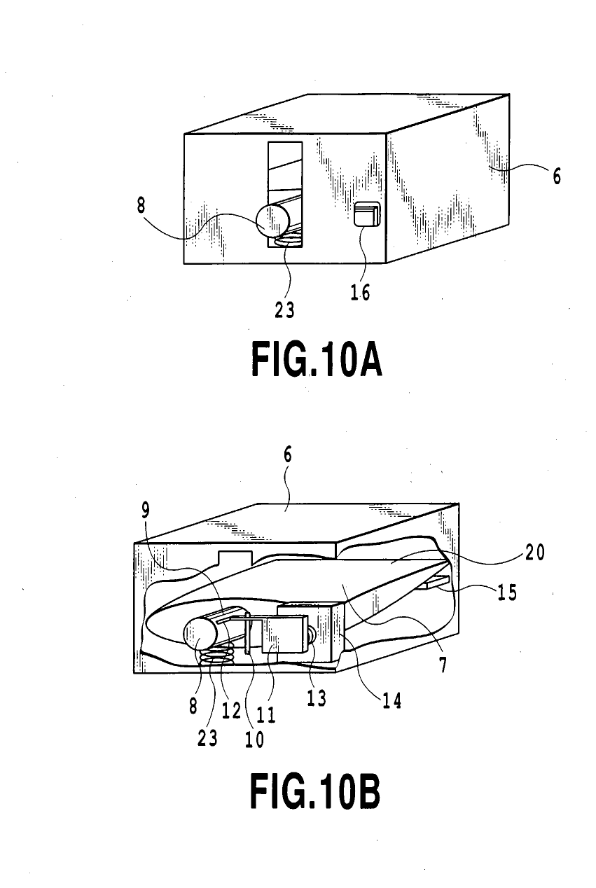

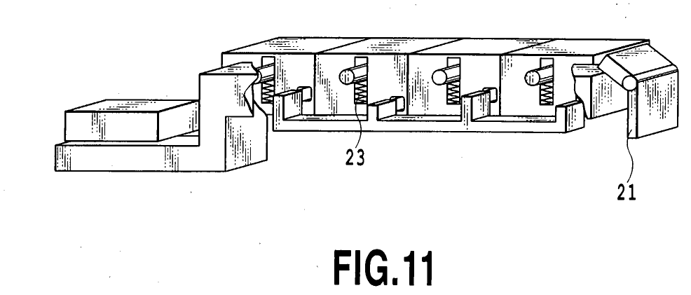

FIG. 9 is a cutaway perspective view showing the vicinity of an engaging portion of an ink supply base with main tanks in an ink supplying system of a printer according to a second embodiment of the present invention. FIG. 10A is a perspective view of an external appearance of the main tank shown in FIG. 9. FIG. 10B is a cutaway perspective view for showing the inside of the main tank. FIG. 11 is a perspective view showing a state in which sub-joints are joined with the respective sub-tanks by causing the ink supply base to move upward from a state shown in FIG. 9. Note that, in these drawings, the same reference numerals are given to members and portions that carry out the same functions as those in the first embodiment.

This embodiment is different from the first embodiment firstly in a point that a lock mechanism 21 for properly locking the ink supply base 3 is provided as a part of the configuration of the printer body. In a state in which the sub-joints 4 and the sub-tanks are disjoined, in other words, at least when the ink supply base 3 is at the lowered position, this lock mechanism 21 locks the ink supply base 3 at the position. On the other hand, when the sub-joints 4 and the respective sub-tanks are joined with one another, the lock mechanism 21 releases the lock of the ink supply base 3, and allows it to move upward, that is, allows the sub-joints 4 and the respective sub-tanks to be joined with one another. In addition, the main tank 2 of this embodiment is provided with a spring 23 biasing the ink supply port forming member 8 upward.

Once the main tanks are mounted, the ink-supply-path forming members 8 become capable of moving. At this moment, in a state where the sub-joints 4 and the sub-tanks are not joined, the lock mechanism 21 locks the ink supply base 3 at the lowered position, and the springs 23 are compressed, as shown in FIG. 9. Thus, biasing forces applied to the ink-supply-port forming members 8 are constrained. When the sub-joints 4 are joined with the respective sub-tanks, the lock of the ink supply base 3 is released. Thus, the ink-supply-path forming members 8 are moved by using the biasing forces of the springs 23.

In this embodiment, the following effect can be obtained in addition to the same effects as the foregoing first embodiment. Specifically, when the sub-joints 4 are joined with the respective sub-tanks, the springs 23 facilitate the ink-supply-port forming members 8 to move. With the assistance of the spring 23, it is possible to reduce the load, on the driving means, for moving the ink supply base 3 upward. Moreover, by adopting a spring suitably selected in view of the biasing force, the spring can be used not only for moving the ink-supply-port forming member 8, but also for actively engaging in moving the ink supply base 3 upward. In this way, it is possible to further reduce a load on the driving means when the sub-joints 4 and the sub-tanks are joined with one another. In particular, at the time of joining, it is necessary to use a relatively large force for causing the sub-joints 4 to enter the respective sub-tanks, or the like. Accordingly, it is preferable to reduce the driving force used for moving the ink supply base 3, the ink-supply-port forming members 8 and thus the ink bags 7.

### Third Embodiment

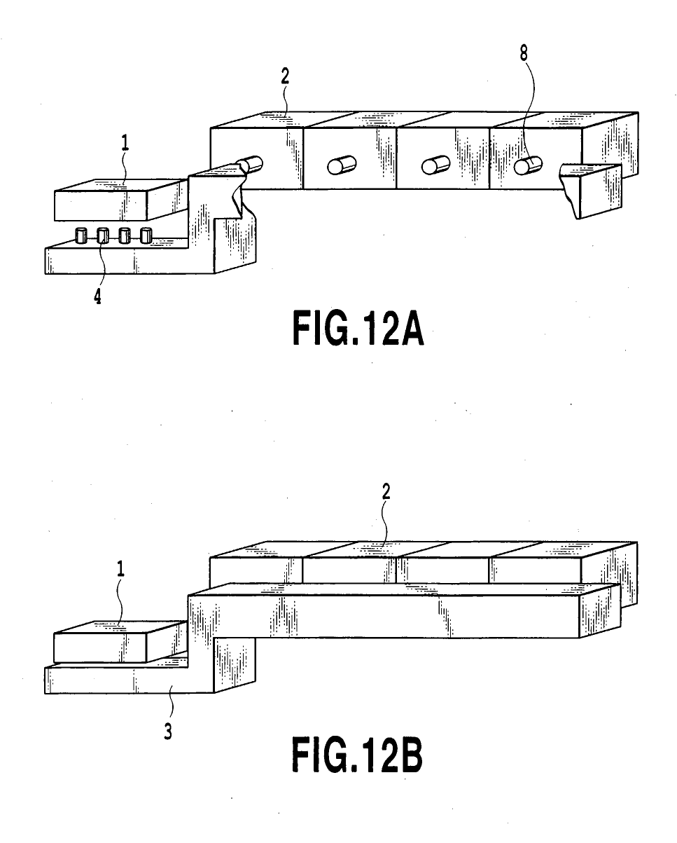

FIG. 12A is a cutaway perspective view of the vicinity of an engaging portion of the ink supply base with the main tanks in an ink supplying system of a printer according to a third embodiment of the present invention. FIG. 12B is a perspective view showing a state in which sub-joints are joined with the respective sub-tanks by moving the ink supply base upward from a state shown in FIG. 12A. Note that, in these drawings, the same reference numerals are given to members and portions that carry out the same functions as those in the first embodiment.

This embodiment is different from each of the foregoing embodiments in a point that, instead of parts of the main tanks 2, that is, the ink-supply-port forming members 8 and the ink bags 7, the entire main tanks 2 are capable of moving along with the joining/releasing between the sub-joints 4 and the sub-tanks 100A.

For this purpose, the configuration of this embodiment is not provided with members for moving just parts of the main tank 2, that is, the components of the main tank such as the pivot member 11, the window 16 and the opening 6A, and components of the printer such as the protrusion 17 and the supporting member 18. The ink-supply-port forming members 8 are fixed to the respective main tanks 2, and are directly connected to the respective main joints of the ink supply base 3. Moreover, the ink supply base 3 and the main tanks 2 (or the mounting portions thereof) are supported by driving means (not illustrated) for making the joining/releasing between the sub-joints 4 and the respective sub-tanks, and thus are capable of integrally moving at a time of the joining/releasing.

According to this embodiment, it is also possible to increase the degree of freedom of material selection for the ink-supply-path forming member, and to improve the liquid resistance property, durability and gas barrier property, as is the case with the foregoing first embodiment.

In the case of this embodiment, a relatively large load on the driving means is needed, since the entire main tanks 2 are moved together. However, without using a highly flexible material for the ink-supply-path forming member, it is possible to cause the preferable movement for joining, while preventing unpreferable stresses from occurring. Furthermore, the structure of the main tank 2 is made simpler than otherwise. For example, it is not necessary to provide the ink bag 7 in order to move only a part of the main tank 2. As a result, ink tanks having various kinds of configurations can be adopted. Moreover, the ink supply base 3 is a component separate from the main tanks 2, and this increases the degree of layout freedom of the main tanks 2, and thus the degree of layout freedom of each component in the apparatus.

Incidentally, this embodiment has a construction in which the joining/releasing direction of the sub-joints 4 to the respective sub-tanks, that is, the moving direction of the ink supply base 3 is along with the vertical or gravity direction. However, the joining/disjoing or moving direction may be along with a horizontal direction. In this case, since the entire main tanks 2 are displaced in the horizontal direction rather than the vertical direction, a load on the driving means is smaller than the case where the vertical movement is performed. Further, the mixing effect on the ink including the pigment is obtained because the ink contained in the main tank is shaken by such the horizontal movement.

### (Others)

Note that, needless to say, it is possible to appropriately determine any joining direction and mode for the intermittent ink supply.

Additionally, although the configuration conforming to four color inks is described in each of the foregoing embodiments, it goes without saying that the color tones (colors and densities) of the inks and the number of ink tanks are not limited to four.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-350806, filed Dec. 5, 2005, which is hereby incorporated by reference herein in its entirety.

1. An ink jet printing apparatus which uses a printing head capable of ejecting ink, an ink reservoir holding ink to be supplied to the printing head, and an ink tank with a larger volume of ink contained therein than in the ink reservoir, and in which ink is supplied from the ink tank to the ink reservoir by intermittently making fluid communication between the ink tank and the ink reservoir, the ink jet printing apparatus comprising,
a supply-path forming member provided for the ink supply, the supply-path forming member integrally including a joint portion capable of being joined with the ink reservoir, and a connection portion connected to the ink tank, and in which a channel for supplying ink is formed between the joint portion and the connection portion, wherein:
the supply-path forming member is configured of a member of an inflexible material; and
movement of the entire supply-path forming member causes the joint portion to be joined with and to be disjoined from the ink reservoir.

2. An ink jet printing apparatus as claimed in claim 1, wherein:
the printing head and the ink reservoir are mounted on a carriage scanned on a printing medium; and
the joint portion is joined with and disjoined from the ink reservoir by moving the supply-path forming member, when the carriage is located at a predetermined position in the scan direction.

3. An ink jet printing apparatus as claimed in claim 1, wherein at least a part of the ink tank to be connected to the connecting portion is moved along with the movement of the supply-path forming member.

4. An ink jet printing apparatus as claimed in claim 1, wherein the entire ink tank to be connected to the connecting portion is moved along with the movement of the supply-path forming member.

5. An ink jet printing apparatus as claimed in claim 4, wherein the moving direction of the supply-path forming member is along with a vertical direction.

6. An ink jet printing apparatus as claimed in claim 4, wherein the moving direction of the supply-path forming member is along with a horizontal direction.

7. An ink tank capable of being mounted on a fixed position in the ink jet printing apparatus as claimed in claim 1, wherein
in a state where the ink tank is mounted on the ink jet printing apparatus, an ink-supply-port forming member, which is connected to the connection portion, provided for introducing the ink, of the ink jet printing apparatus, is supported movably together with the connection portion.

8. An ink tank as claimed in claim 7, comprising:
a containing portion which is provided with the ink-supply-port forming member, and in which ink is contained; and
a case, housing the containing portion therein, and including a supporting member which supports a part of the containing portion, the part being different from a part to which the ink-supply-port forming member is provided, wherein
the containing portion is capable of swinging around the part at which the containing portion is supported by the supporting member in the case with the movement of the ink-supply-port forming member.

9. An ink tank as claimed in claim 8, wherein the ink containing portion is provided with a movable member which is capable of moving in the containing portion.

10. An ink tank as claimed in claim 7, further comprising a member which prohibits the ink-supply-port forming member from moving, in a state where the ink tank is not mounted on the ink jet printing apparatus; and which allows the ink-supply-port forming member to move by engaging with an engaging member of the ink jet printing apparatus, in a state where the ink tank is mounted on the ink jet printing apparatus.

11. An ink tank as claimed in claim 10, wherein the kind of the ink contained in the ink tank determines the relationship of the ink tank to the engaging member of the ink jet printing apparatus.

12. An ink tank as claimed in claim 7, further comprising biasing means which biases the ink-supply-port forming member in a direction of the movement.

13. An ink jet printing apparatus as claimed in claim 1, which uses the ink tank as claimed in claim 10, comprising an engaging member which engages with the member of the ink tank, the member prohibiting and allowing the movement of the ink-supply-port forming member.

14. An ink jet printing apparatus as claimed in claim 1, which uses the ink tank as claimed in claim 12, comprising a lock mechanism constraining an action of a biasing force of the biasing member by locking the movement of the supply-path forming member in a state where the joint portion is not joined with the ink reservoir.
